(19) United States
(12) Patent Application Publication
(10) Pub. No.: US 2026/0264638 A1
(43) Pub. Date: Sep. 10, 2026

(54) AIRBAG DEVICE

(71) Applicant: SUBARU CORPORATION, Tokyo (JP)

(72) Inventor: Hidekazu ABE, Tokyo (JP)

(21) Appl. No.: 19/544,486

(22) Filed: Feb. 19, 2026

(30) Foreign Application Priority Data
Mar. 5, 2025 (JP) 2025-035053

(51) Int. Cl. B60R 21/2334

(52) U.S. Cl. CPC B60R 21/2334

(57) ABSTRACT

An airbag device includes an airbag main body, a diaphragm, an inflator, a coupling member, and a removing mechanism. The diaphragm is disposed inside the airbag main body, divides an internal space of the airbag main body into an upper space and a lower space, and has a ventilation hole allowing communication between the upper space and the lower space. The inflator is configured to eject a gas into one of the lower space and the upper space of the airbag main body from a gas inflow port of the airbag main body. The coupling member is configured to detachably couple an outer peripheral portion of the diaphragm to an inner surface of the airbag main body. The removing mechanism is configured to remove the diaphragm coupled to the inner surface of the airbag main body according to a state of an occupant seated on a seat.

### CROSS-REFERENCE TO RELATED APPLICATIONS

The present application claims priority from Japanese Patent Application No. 2025-035053 filed on Mar. 5, 2025, the entire contents of which are hereby incorporated by reference.

### BACKGROUND

The disclosure relates to an airbag device.

In the related art, a vehicle is provided with a protection device that protects an occupant when an object collides with the vehicle.

### SUMMARY

An aspect of the disclosure provides an airbag device including an airbag main body, a diaphragm, an inflator, a coupling member, and a removing mechanism. The diaphragm is disposed inside the airbag main body, divides an internal space of the airbag main body into an upper space and a lower space, and has a ventilation hole allowing communication between the upper space and the lower space. The inflator is configured to eject a gas into one of the lower space and the upper space of the airbag main body from a gas inflow port of the airbag main body. The coupling member is configured to detachably couple an outer peripheral portion of the diaphragm to an inner surface of the airbag main body. The removing mechanism is configured to remove the diaphragm coupled to the inner surface of the airbag main body according to a state of an occupant seated on a seat.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a side view illustrating a configuration of a vehicle according to an embodiment of the disclosure.

FIG. 2 is a perspective view illustrating a configuration of an airbag device according to the embodiment.

FIG. 3 is a cross-sectional view illustrating an airbag main body as viewed from above a diaphragm according to the embodiment.

FIG. 4 is a partial enlarged view illustrating a coupling structure body according to the embodiment.

FIG. 5 is a partial enlarged view illustrating a locking portion between a first actuator and the other end of a suture thread according to the embodiment, as viewed from the front.

FIG. 6 is a partial enlarged view illustrating the locking portion between the first actuator and the other end of the suture thread according to the embodiment, as viewed from the top.

FIG. 7 is a partial enlarged view illustrating the first actuator when a pin is in a retracted state according to the embodiment, as viewed from the front.

FIG. 8 is a block diagram illustrating an example of a configuration of a control device according to the embodiment.

FIG. 9 is a block diagram illustrating an example of a functional configuration of the control device according to the embodiment.

FIG. 10 is a perspective view illustrating the airbag device in a state in which the diaphragm is removed from an inner surface of the airbag main body by a removing mechanism according to the embodiment.

FIG. 11 is a schematic diagram illustrating pressure inside the airbag main body when the diaphragm is not removed according to the embodiment.

FIG. 12 is a schematic diagram illustrating pressure inside the airbag main body when the diaphragm is removed according to the embodiment.

### DETAILED DESCRIPTION

Japanese Unexamined Patent Application Publication (JP-A) No. 2020-75565 discloses a technique of protecting an occupant by deploying an airbag during a collision of a vehicle. JP-A No. 2020-75565 discloses a pressure sensor that detects pressure applied to the vehicle and an acceleration sensor that detects an acceleration in order to detect a collision of a vehicle. In JP-A No. 2020-75565, when a detection value of the pressure sensor is a threshold or more and a detection value of the acceleration sensor is a threshold or more, a collision of the vehicle is detected and an airbag is deployed.

For example, at the time of a front collision of a vehicle, an occupant in a vehicle cabin of the vehicle is moved to a front side of the vehicle due to an impact of the collision, and an impact on the occupant is relieved by a collision with a deployed airbag. At this time, when the occupant wears a seatbelt, a restraint force of the seatbelt and a restraint force caused by pressure in a lower portion of the airbag act on the chest of the occupant, and a restraint force caused by pressure in an upper portion of the airbag acts on the head of the occupant.

On the other hand, when the occupant does not wear a seatbelt, a restraint force caused by pressure in the upper portion of the airbag acts on the head of the occupant, and a restraint force caused by pressure in a lower portion of the airbag acts on the chest of the occupant. In this manner, at the time of a vehicle collision, the distribution of restraint forces acting respectively on the head and the chest of the occupant may change in accordance with a state of the occupant, such as whether the occupant wears the seatbelt, and a load on the neck of the occupant may increase. Therefore, it is desirable to appropriately change the pressure in the upper portion and the pressure in the lower portion of the airbag in accordance with a state of the occupant at the time of a vehicle collision so as to improve safety of the occupant.

It is desirable to appropriately change pressure in an upper portion and pressure in a lower portion of an airbag in accordance with a state of an occupant at the time of a vehicle collision so as to improve safety of the occupant.

Hereinafter, an embodiment of the disclosure will be described in detail with reference to the accompanying drawings. Specific dimensions, materials, numerical values, or the like described in the embodiment are merely examples for facilitating the understanding of the disclosure, and are not intended to limit the disclosure unless otherwise specified. Relative sizes of elements illustrated in the drawings do not necessarily accurately express a magnitude relationship between actual elements. In the specification and the drawings, elements having substantially the same effects and configurations are denoted by the same reference signs, and duplicate descriptions will be omitted. Elements which are not directly related to the disclosure may be omitted in the drawings.

FIG. 1 is a side view illustrating a configuration of a vehicle 100 according to the present embodiment. In FIG. 1, a Z direction indicates a vertical direction, an X direction indicates a predetermined direction in a horizontal direction, and a Y direction indicates a direction orthogonal to the X direction in the horizontal direction. The X direction is, for example, a front-rear direction of the vehicle 100, the -X direction is a front direction of the vehicle 100, and the +X direction is a rear direction of the vehicle 100. The Y direction is, for example, a left-right direction of the vehicle 100, the -Y direction is a left direction of the vehicle 100, and the +Y direction is a right direction of the vehicle 100.

The vehicle 100 is, for example, a hybrid vehicle equipped with two drive sources of an engine and a drive motor. A drive source of the vehicle 100 may be an engine alone or a drive motor alone, and various vehicle types such as an engine vehicle and an electric vehicle may be adopted. Here, a configuration related to a feature of the embodiment will be described in detail, and a configuration unrelated to a feature of the embodiment will not be described.

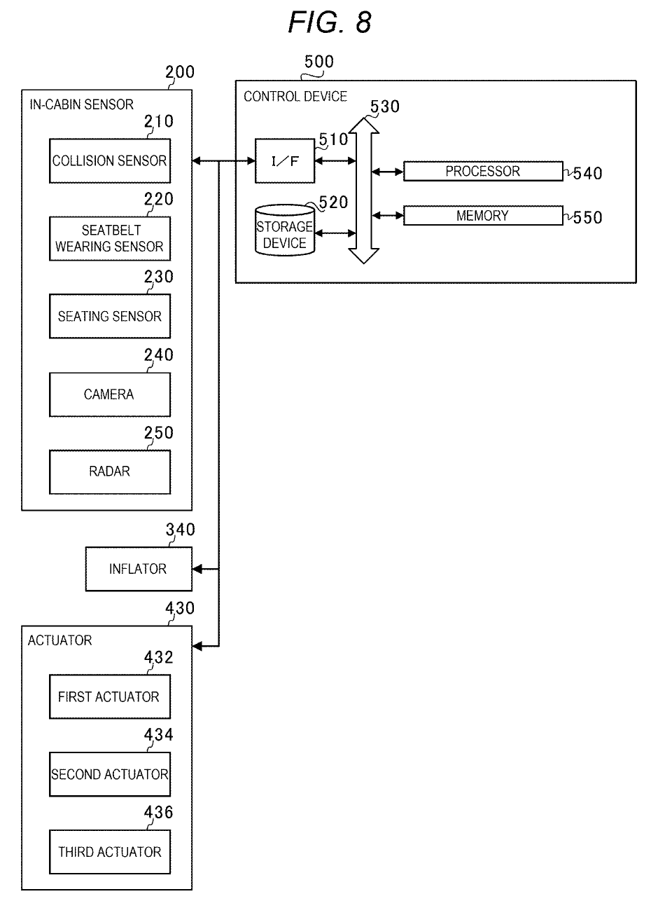

As illustrated in FIG. 1, the vehicle 100 includes an in-cabin sensor 200 and an airbag device 300. As will be described later in FIG. 8, the in-cabin sensor 200 includes a collision sensor 210, a seatbelt wearing sensor 220, a seating sensor 230, a camera 240, and a radar 250.

The collision sensor 210 detects a collision between the vehicle 100 and an object, and transmits a signal indicating the collision between the vehicle 100 and the object to a control device 500. The collision sensor 210 is, for example, a pressure sensor that detects pressure applied to the vehicle 100. In this case, a signal indicating pressure of a threshold or more detected by the pressure sensor is the signal indicating the collision between the vehicle 100 and the object. The collision sensor 210 is, for example, an acceleration sensor that detects an acceleration applied to the vehicle 100. In this case, a signal indicating an acceleration of a threshold or more detected by the acceleration sensor is the signal indicating the collision between the vehicle 100 and the object.

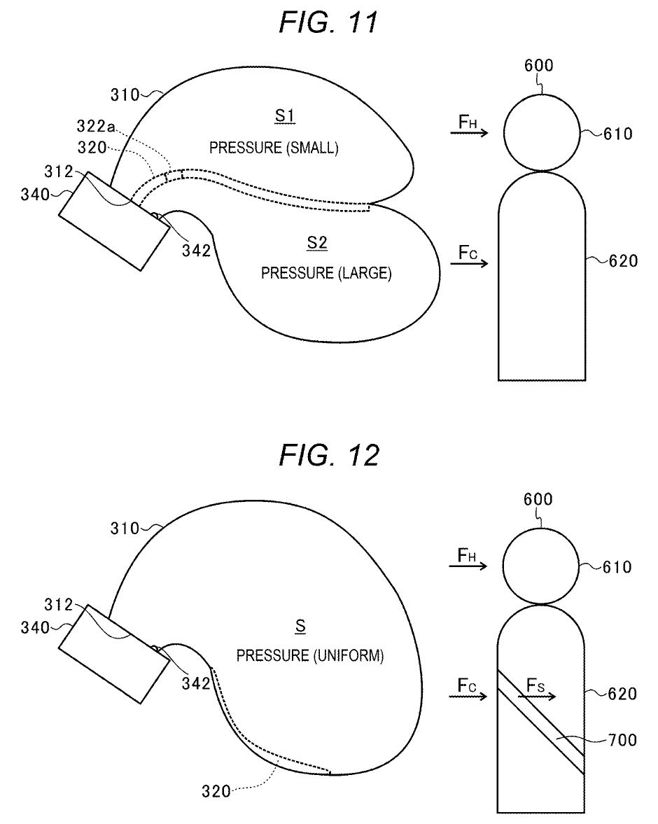

The seatbelt wearing sensor 220 is a sensor that detects whether an occupant 600 (see FIG. 11) riding in the vehicle 100 wears a seatbelt 700 (see FIG. 12). The seatbelt wearing sensor 220 is provided to the seatbelt 700 disposed in a vehicle cabin of the vehicle 100. The seatbelt wearing sensor 220 transmits a detected signal indicating whether the seatbelt 700 is worn to the control device 500.

The seating sensor 230 is a sensor that detects a load applied to a seat from the occupant 600 seated on the seat. The seating sensor 230 is provided to a seat disposed in the vehicle cabin of the vehicle 100. The seating sensor 230 transmits a signal indicating the detected load applied to the seat to the control device 500.

The camera 240 is an imaging device, and is, for example, a digital camera using an imaging device such as a charge coupled device (CCD) or a complementary metal oxide semiconductor (CMOS). The camera 240 images an environment inside the vehicle cabin of the vehicle 100. The camera 240 detects a size and a posture of the occupant 600 included in an image imaged by the imaging device. The camera 240 according to the embodiment is a stereo camera. Based on a parallax of an image imaged by the imaging device, the camera 240 detects a distance from the camera 240 to the occupant 600 in the vehicle cabin. The camera 240 transmits a signal indicating a detected size and posture of the occupant 600, and a detected distance to the occupant 600 to the control device 500.

The radar 250 radiates, for example, millimeter waves as transmission waves into the vehicle cabin of the vehicle 100, and receives reflected waves of the transmission waves. The radar 250 detects a distance and an azimuth from the radar 250 to the occupant 600 in the vehicle cabin based on a time difference between transmission and reception and radiation directions of the transmission waves. The radar 250 detects a size and a posture of the occupant 600 based on the detected distance and azimuth. The radar 250 transmits a signal indicating the detected size and posture of the occupant 600, and a detected distance and azimuth to the occupant 600 to the control device 500.

The airbag device 300 is a protection device that protects the occupant 600 from an impact of a collision of the vehicle 100. The airbag device 300 is disposed in the vehicle cabin of the vehicle 100. For example, the airbag device 300 is disposed in a member disposed in front of a seat in the vehicle cabin.

In one example, when the seat is a driver's seat, the airbag device 300 is disposed inside a steering wheel disposed in front of the driver's seat. When the seat is a front passenger's seat, the airbag device 300 is disposed inside an instrument panel disposed in front of the front passenger's seat.

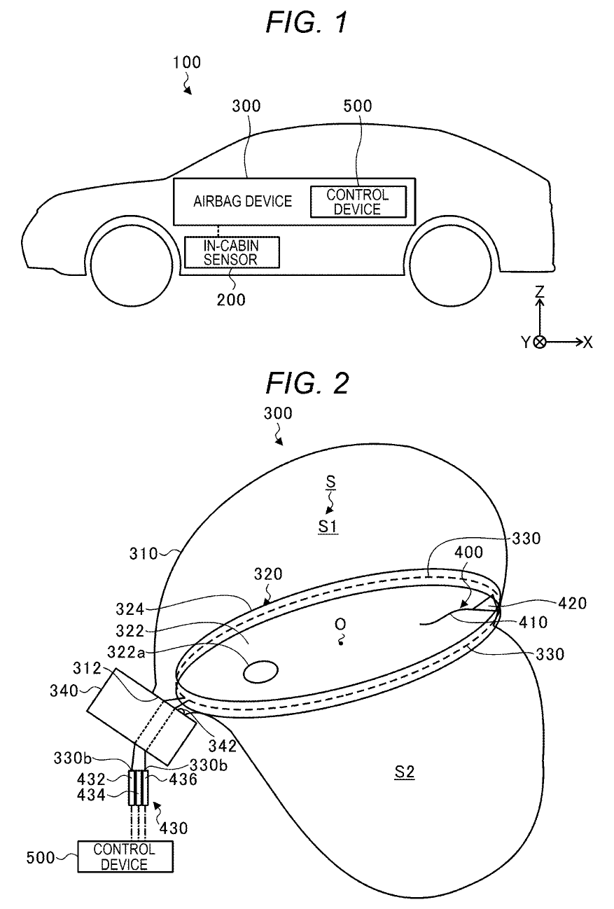

FIG. 2 is a perspective view illustrating a configuration of the airbag device 300 according to the present embodiment. FIG. 2 illustrates an inflated and deployed state of an airbag main body 310 of the airbag device 300. As illustrated in FIG. 2, the airbag device 300 includes the airbag main body 310, a diaphragm 320, a suture thread 330, an inflator 340, and a removing mechanism 400.

The airbag main body 310 is a bag body obtained by forming a sheet of cloth into a bag shape. However, this is not to be construed in a limiting sense. The airbag main body 310 may be a bag body obtained by sewing cloths and forming the sewn cloths into a bag shape. At the time of a collision of the vehicle 100, the airbag main body 310 is inflated and deployed by supplying a gas into the airbag main body 310 so as to relieve an impact of the collision applied to the occupant 600.

The airbag main body 310 is accommodated, for example, in a state of being folded inside a steering wheel or an instrument panel. In the present embodiment, the airbag main body 310 is inflated and deployed from the steering wheel or the instrument panel to a rear side of the vehicle 100 by supplying a gas from the inflator 340 at the time of a collision of the vehicle 100.

The airbag main body 310 has one opening 312. The entire periphery of the opening 312 is coupled to a housing of the inflator 340. That is, the opening 312 of the airbag main body 310 is closed by the housing of the inflator 340. The opening 312 communicates with a gas ejection port 342 through which the gas is ejected from the inflator 340. The opening 312 is a gas inflow port into which the gas ejected from the inflator 340 flows.

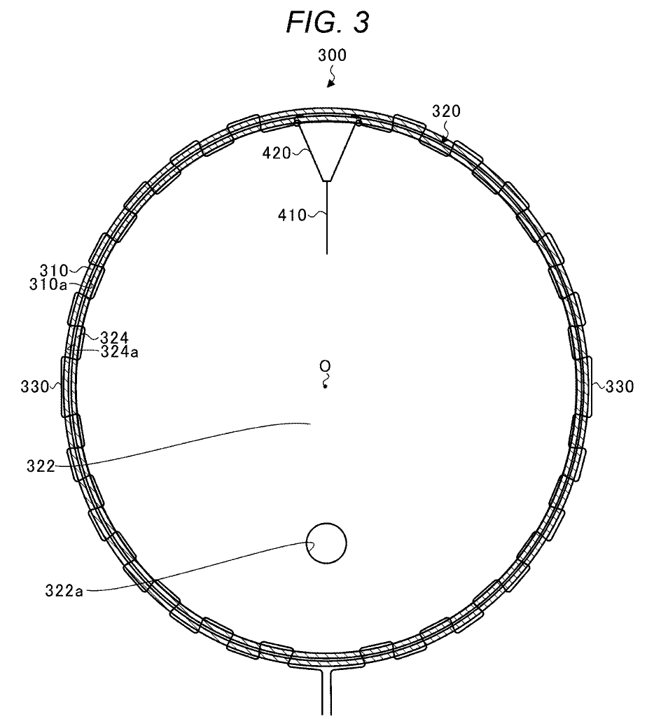

The diaphragm 320 is provided inside the airbag main body 310, and divides an internal space S of the airbag main body 310 into an upper space S1 and a lower space S2. In the present embodiment, the diaphragm 320 is attached to an inner surface 310a (see FIG. 3) of the airbag main body 310 by sewing with the suture thread 330.

FIG. 3 is a cross-sectional view illustrating the airbag main body 310 as viewed from above from the diaphragm 320 according to the present embodiment. As illustrated in FIG. 3, the diaphragm 320 includes a partition portion 322 and an outer peripheral portion 324. The partition portion 322 partitions the internal space S of the airbag main body 310 into the upper space S1 and the lower space S2. The partition portion 322 has a shape and a size corresponding to a cross-sectional shape of the inner surface 310a of the airbag main body 310 when the airbag main body 310 is inflated and deployed.

In the present embodiment, the shape corresponding to the cross-sectional shape of the inner surface 310a of the airbag main body 310 is, for example, an elliptic shape. However, this is not to be construed in a limiting sense. The shape corresponding to the cross-sectional shape of the inner surface 310a of the airbag main body 310 may be another shape such as a circular shape, a triangular shape, or a quadrangular shape.

As illustrated in FIG. 2, the partition portion 322 partitions the internal space S of the airbag main body 310 into the upper space S1 above the partition portion 322 and the lower space S2 below the partition portion 322. That is, the partition portion 322 of the diaphragm 320 divides the internal space S of the airbag main body 310 into the upper space S1 and the lower space S2.

A vent hole (ventilation hole) 322a is provided in the partition portion 322. The vent hole 322ais a through hole that penetrates the partition portion 322 from an upper surface to a lower surface. The vent hole 322aallows communication between the upper space S1 and the lower space S2. The vent hole 322ais, for example, circular. However, this is not to be construed in a limiting sense. The vent hole 322a may have another shape such as an elliptic shape, a triangular shape, or a quadrangular shape.

As illustrated in FIG. 2, the vent hole 322a is provided on a side closer to the inflator 340 than a center O of the partition portion 322. However, this is not to be construed in a limiting sense. The vent hole 322amay be provided on a side opposite to the inflator 340 across the center O of the partition portion 322. In addition, one vent hole 322ais provided in the partition portion 322. However, this is not to be construed in a limiting sense. Multiple vent holes 322amay be provided in the partition portion 322.

The outer peripheral portion 324 is provided on an outer periphery of the partition portion 322 and serves as a coupling portion of the diaphragm 320, which is coupled to the inner surface 310a of the airbag main body 310. The outer peripheral portion 324 is continuous with an outer periphery of the partition portion 322 and stands upright toward the upper space S1 with respect to the partition portion 322. An angle between the outer peripheral portion 324 and the partition portion 322 is, for example, 90°. However, this is not to be construed in a limiting sense. An angle between the outer peripheral portion 324 and the partition portion 322 may be less than 90° or larger than 90°.

As illustrated in FIG. 3, an outer surface 324a of the outer peripheral portion 324 faces the inner surface 310a of the airbag main body 310. The outer peripheral portion 324 is sewn to the airbag main body 310 with the suture thread 330 so as to be detachably coupled to the inner surface 310a of the airbag main body 310.

The suture thread 330 is an example of a coupling member that detachably couples the outer peripheral portion 324 of the diaphragm 320 to the inner surface 310a of the airbag main body 310. Hereinafter, an example of using the suture thread 330 as a coupling member that detachably couples the outer peripheral portion 324 of the diaphragm 320 to the inner surface 310a of the airbag main body 310 will be described. However, this is not to be construed in a limiting sense. The coupling member that detachably couples the outer peripheral portion 324 of the diaphragm 320 to the inner surface 310a of the airbag main body 310 may be another member such as glue, adhesive, or magic tape (Registered Trademark).

As illustrated in FIG. 3, the airbag main body 310 and the outer peripheral portion 324 are sewn with the suture thread 330 such that the outer surface 324a of the outer peripheral portion 324 of the diaphragm 320 is coupled to the inner surface 310a of the airbag main body 310. The airbag main body 310 and the outer peripheral portion 324 are sewn with the suture thread 330 over approximately the whole periphery of the airbag main body 310 and the outer peripheral portion 324. The diaphragm 320 is positioned and held on the inner surface 310a of the airbag main body 310 by being sewn with the suture thread 330.

Referring back to FIG. 2, the inflator 340 is a gas generation device that ignites an explosive and generates a gas by a chemical reaction due to combustion. The gas generated by the inflator 340 is introduced into the internal space S of the airbag main body 310 through the gas ejection port 342 of the inflator 340 from the opening 312 of the airbag main body 310.

In the present embodiment, the gas ejection port 342 of the inflator 340 is disposed below the diaphragm 320 in the opening 312 of the airbag main body 310. Therefore, the gas ejected from the gas ejection port 342 passes below the diaphragm 320 in the opening 312 and is supplied to the lower space S2 of the airbag main body 310.

The gas supplied to the lower space S2 inflates the lower space S2 of the airbag main body 310. The gas supplied to the lower space S2 is supplied to the upper space S1 via the vent hole 322a of the diaphragm 320. Then, the gas supplied to the upper space S1 inflates the upper space S1 of the airbag main body 310.

Accordingly, the lower space S2 and the upper space S1 of the airbag main body 310 can be inflated by pressure of the gas ejected from the gas ejection port 342 of the inflator 340, and the airbag main body 310 can be deployed. As a result, when an object collides with the vehicle 100, the airbag main body 310 is deployed between, for example, a steering wheel or an instrument panel of the vehicle 100 and a seat, so that the occupant 600 can be protected from an impact of the collision.

The removing mechanism 400 is a mechanism that uncouples the airbag main body 310 and the diaphragm 320 and removes the diaphragm 320 from a coupling portion between the inner surface 310a of the airbag main body 310 and the outer peripheral portion 324 of the diaphragm 320. As illustrated in FIG. 2, the removing mechanism 400 includes a suture releasing thread 410, a coupling structure body 420, an actuator 430, and the control device 500.

The suture releasing thread 410 is an example of a coupling member to which one end of the outer peripheral portion 324 of the diaphragm 320 is coupled. In the embodiment, an example of using the suture releasing thread 410, which is a thread made of the same material as the suture thread 330, as the coupling member to which the one end of the outer peripheral portion 324 of the diaphragm 320 is coupled, will be described. However, this is not to be construed in a limiting sense. The coupling member to which the one end of the outer peripheral portion 324 of the diaphragm 320 is coupled may be another member such as a metal wire, a flexible resin, or rubber.

The suture releasing thread 410 is a thread that is directly or indirectly coupled to the outer peripheral portion 324 of the diaphragm 320 and the suture thread 330. In the present embodiment, the suture releasing thread 410 is indirectly coupled to the outer peripheral portion 324 of the diaphragm 320 and the suture thread 330 via the coupling structure body 420.

However, the coupling structure body 420 is not an essential configuration, and the suture releasing thread 410 may be directly coupled to the outer peripheral portion 324 of the diaphragm 320 and the suture thread 330 as long as a coupling strength with the outer peripheral portion 324 of the diaphragm 320 and the suture thread 330 can be ensured. For example, the suture releasing thread 410 may be used to sew the outer peripheral portion 324 of the diaphragm 320 and the suture thread 330, so that a coupling strength with the outer peripheral portion 324 and the suture thread 330 is ensured, and the outer peripheral portion 324 and the suture thread 330 may be directly coupled to each other.

As illustrated in FIG. 2, the coupling structure body 420 is provided at a position opposite to the inflator 340 across the center O among the outer peripheral portion 324 of the diaphragm 320. In one example, the coupling structure body 420 is provided at a position farthest from the inflator 340, among the outer peripheral portion 324 of the diaphragm 320. That is, the coupling structure body 420 is provided at a position closest to the occupant 600 among the outer peripheral portion 324 of the diaphragm 320.

As illustrated in FIG. 3, a total length of the suture releasing thread 410 is shorter than a major axis of the elliptic diaphragm 320. In one example, the total length of the suture releasing thread 410 is shorter than half of the major axis of the elliptic diaphragm 320. When the diaphragm 320 has a circular shape, the total length of the suture releasing thread 410 is shorter than a diameter of the circular diaphragm 320. In one example, the total length of the suture releasing thread 410 is shorter than a radius of the circular diaphragm 320. The total length of the suture releasing thread 410 is, for example, 5 cm.

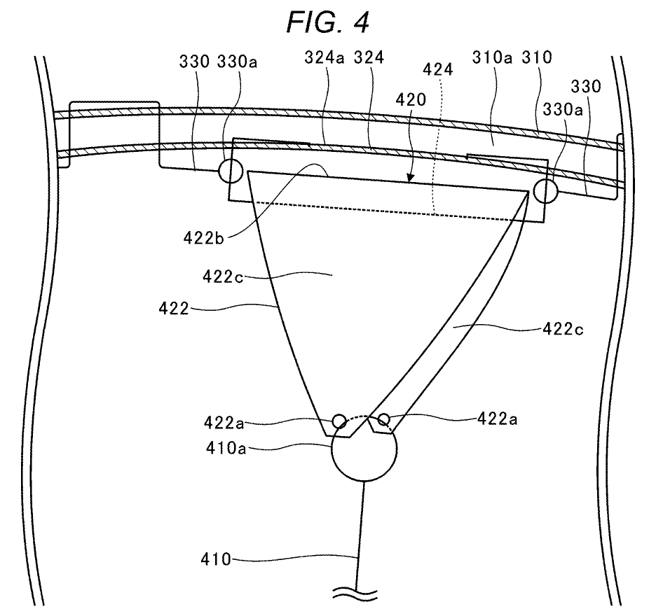

FIG. 4 is a partial enlarged view illustrating the coupling structure body 420 according to the present embodiment. The coupling structure body 420 couples the suture releasing thread 410 to the outer peripheral portion 324 of the diaphragm 320. As illustrated in FIG. 4, the coupling structure body 420 includes a cloth 422 and staples 424.

The cloth 422 is coupled to the suture releasing thread 410, and the staples 424 fix the cloth 422 to the outer peripheral portion 324 of the diaphragm 320. As illustrated in FIG. 4, needles of the staples 424 are fixed to the outer peripheral portion 324 of the diaphragm 320. The staple 424 is an example of a fixing member that fixes the cloth 422 to the outer peripheral portion 324.

The cloth 422 is an example of a coupling member that couples one end 410a of the suture releasing thread 410 and the staples 424. The cloth 422 has, for example, a rhombic shape. A through hole 422ais formed at each of apexes in a pair on a longer diagonal line of two diagonal lines of the rhombic cloth 422.

The cloth 422 includes a folded portion 422b where the cloth 422 is folded about a shorter diagonal line of the two diagonal lines. The folded portion 422bis disposed between the outer peripheral portion 324 and the staples 424. That is, the staples 424 fix and hold the folded portion 422b of the cloth 422 by interposing the folded portion 422b between the staples 424 and the outer peripheral portion 324.

The cloth 422 includes triangular portions 422c in a pair on both sides of the folded portion 422b. One of the triangular portions 422cin the pair is disposed above the staples 424, and the other one is disposed below the staples 424. A part of the staples 424 is covered with the triangular portions 422c in the pair.

The through holes 422a are formed at apexes of the triangular portions 422c that are separated away from the folded portion 422b. The one end 410aof the suture releasing thread 410 is inserted through the through holes 422a in a pair of the triangular portions 422c in the pair. In the present embodiment, the one end 410aof the suture releasing thread 410 is formed into an annular shape. The through holes 422ain the pair are inserted through the annular one end 410a, and the suture releasing thread 410 and the cloth 422 are coupled to each other.

A width of the folded portion 422b of the cloth 422 is larger than a width of the suture releasing thread 410. Therefore, a contact area between the folded portion 422b of the cloth 422 and the staples 424 is larger than a contact area between the suture releasing thread 410 and the outer peripheral portion 324 when the suture releasing thread 410 is directly coupled to the outer peripheral portion 324. Therefore, as will be described in details later, a tensile load applied from the suture releasing thread 410 can be distributed and transmitted to the outer peripheral portion 324.

In the present embodiment, the suture threads 330 in a pair are provided on both sides of the staples 424. That is, the suture threads 330 in the pair are provided on both sides of the staples 424 in a peripheral direction of the outer peripheral portion 324. One end 330a of the suture thread 330 is coupled to the staples 424. In the present embodiment, the one end 330a of the suture thread 330 is formed into an annular shape. A part of the staples 424 is inserted through the annular one end 330a, and the suture threads 330 in the pair and the staples 424 are coupled to each other. However, this is not to be construed in a limiting sense. The suture thread 330 may be not coupled to the staples 424, but may be made of a single thread extending in the peripheral direction of the outer peripheral portion 324 of the diaphragm 320.

Referring back to FIG. 2, the actuator 430 is a switching unit that drives the suture threads 330 in the pair into a locked state in which the suture threads 330 in the pair are locked and an unlocked state in which the suture threads 330 in the pair are unlocked. The actuator 430 is a switching unit that drives the suture releasing thread 410 into a locked state in which the suture releasing thread 410 is locked and an unlocked state in which the suture releasing thread 410 is unlocked. The actuator 430 is a switching unit that drives the suture releasing thread 410 into the locked state in which the suture releasing thread 410 is locked to one end of the outer peripheral portion 324 of the diaphragm 320 when the airbag main body 310 is inflated and the unlocked state in which the suture releasing thread 410 is not locked to the one end of the outer peripheral portion 324 of the diaphragm 320 when the airbag main body 310 is inflated.

As illustrated in FIG. 2, the actuator 430 includes a suture thread actuator coupled to the suture threads 330 in the pair, and a suture releasing thread actuator coupled to the suture releasing thread 410. In one example, the actuator 430 includes a first actuator 432, a second actuator 434, and a third actuator 436. The first actuator 432 and the third actuator 436 are the suture thread actuators, and the second actuator 434 is the suture releasing thread actuator.

The first actuator 432 is engageably coupled to the other end 330b (see FIG. 2) of the suture thread 330, which is opposite to the one end 330a of the suture thread 330 provided on one side (for example, on a left side of the staples 424 in FIG. 4) of the staples 424, between the suture threads 330 in the pair. In one example, as illustrated in FIGS. 2 and 4, the one end 330a of the suture thread 330 is coupled to the staples 424, and the other end 330b of the suture thread 330 is coupled to the first actuator 432. That is, the suture thread 330 couples the staples 424 and the first actuator 432.

In the present embodiment, the first actuator 432 is disposed outside the airbag main body 310. The other end 330bof the suture thread 330 passes through the inside of the housing of the inflator 340, exits to the outside from the inside of the airbag main body 310, and is coupled to the first actuator 432.

The second actuator 434 is engageably coupled to the other end 410b (see FIG. 10) of the suture releasing thread 410 on an opposite side to the one end 410a (see FIG. 4). In one example, as will be illustrated in FIG. 10 later, the one end 410a of the suture releasing thread 410 is coupled to the coupling structure body 420, and the other end 410b of the suture releasing thread 410 is coupled to the second actuator 434. That is, the suture releasing thread 410 couples the coupling structure body 420 and the second actuator 434.

In the present embodiment, the second actuator 434 is provided outside the airbag main body 310. The other end 410bof the suture releasing thread 410 passes through the inside of the housing of the inflator 340, exits to the outside from the inside of the airbag main body 310, and is coupled to the second actuator 434.

The third actuator 436 is engageably coupled to the other end 330b (see FIG. 2) of the suture thread 330 on an opposite side to the one end 330a of the suture thread 330 provided on the other side of the staples 424 (for example, on a right side of the staples 424 in FIG. 4), between the suture threads 330 in the pair. In one example, as illustrated in FIGS. 2 and 4, the one end 330a of the suture thread 330 is coupled to the staples 424, and the other end 330b of the suture thread 330 is coupled to the third actuator 436. That is, the suture thread 330 couples the staples 424 and the third actuator 436.

In the present embodiment, the third actuator 436 is disposed outside the airbag main body 310. The other end 330bof the suture thread 330 passes through the inside of the housing of the inflator 340, exits to the outside from the inside of the airbag main body 310, and is coupled to the third actuator 436.

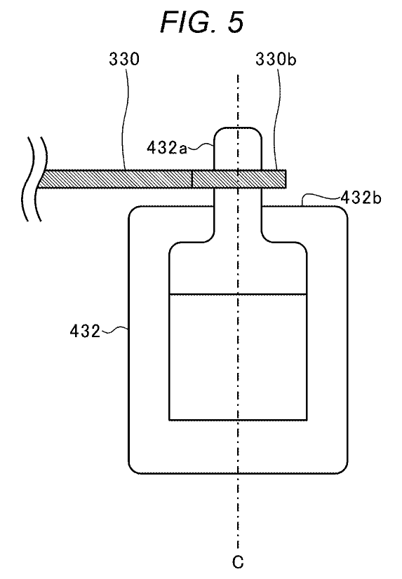

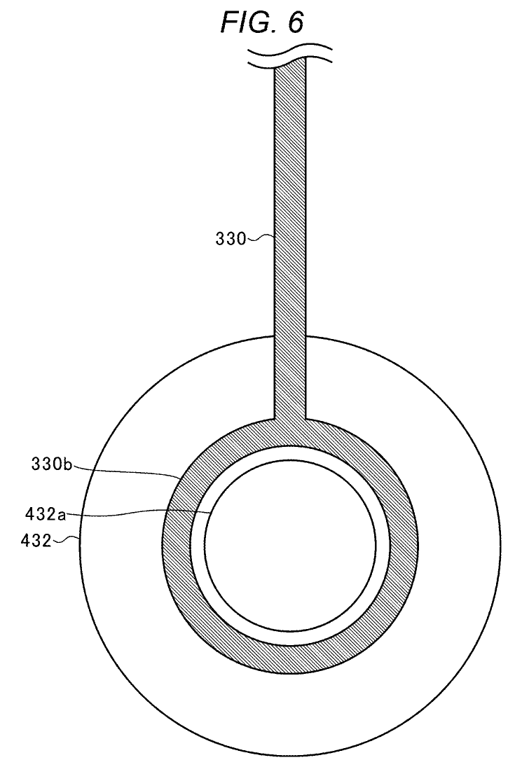

FIG. 5 is a partial enlarged view illustrating a locking portion between the first actuator 432 and the other end 330b of the suture thread 330 according to the embodiment, as viewed from the front. FIG. 6 is a partial enlarged view illustrating the locking portion between the first actuator 432 and the other end 330b of the suture thread 330 according to the embodiment, as viewed from the top.

A locking portion between the second actuator 434 and the other end 410b of the suture releasing thread 410 and a locking portion between the third actuator 436 and the other end 330b of the suture thread 330 are the same as the locking portion between the first actuator 432 and the other end 330b of the suture thread 330. Hereinafter, the locking portion between the first actuator 432 and the other end 330b of the suture thread 330 will be described in detail, and detailed description of the locking portion between the second actuator 434 and the other end 410b of the suture releasing thread 410 and the locking portion between the third actuator 436 and the other end 330b of the suture thread 330 will be omitted.

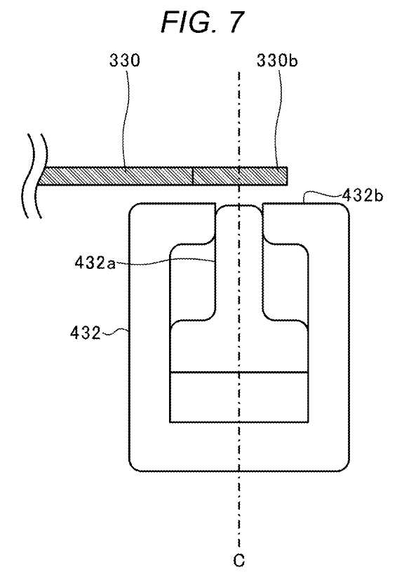

As illustrated in FIG. 5, the first actuator 432 includes a pin 432a. The first actuator 432 is configured such that the pin 432a can be moved in a central axis C direction. The first actuator 432 can be displaced into a protruding state in which the pin 432a protrudes from an upper surface 432b (see FIG. 5) and a retracted state in which the pin 432a is retracted from the upper surface 432b (see FIG. 7).

As illustrated in FIG. 6, the pin 432a has a circular shape in a cross section orthogonal to the central axis C. The other end 330b of the suture thread 330 is formed into an annular shape. An outer diameter of the pin 432ais smaller than an inner diameter of the other end 330b of the suture thread 330. As illustrated in FIG. 5, when the pin 432a is in the protruding state, the pin 432a is inserted through the annular other end 330b, and the suture thread 330 is in the locked state of being locked to the pin 432a.

FIG. 7 is a partial enlarged view illustrating the first actuator 432 when the pin 432a is in the retracted state according to the present embodiment, as viewed from the front. As illustrated in FIG. 7, when the pin 432a is in the retracted state, the pin 432a is detached from the annular other end 330b and the suture thread 330 is in the unlocked state in which the other end 330b of the suture thread 330 and the pin 432a is unlocked.

FIG. 8 is a block diagram illustrating an example of a configuration of the control device 500 according to the present embodiment. The control device 500 controls the airbag device 300. As illustrated in FIG. 8, the control device 500 includes an I/F 510, a storage device 520, a system bus 530, one or more processors 540, and one or more memories 550. The I/F 510 is an interface for communicating with the in-cabin sensor 200, the inflator 340, and the actuator 430.

The storage device 520 includes a RAM, a flash memory, an HDD, and the like, and stores various kinds of information necessary for processing executed by the processor 540 to be described below. The system bus 530 is a transmission path that electrically couples the I/F 510, the storage device 520, the processor 540, and the memory 550, and transmits data among these components.

The processor 540 includes, for example, a central processing unit (CPU). The memory 550 includes, for example, a read memory (ROM) and a random access memory (RAM). The ROM is a storage element that stores a program, a calculation parameter, and the like to be used by the CPU. The RAM is a storage element that temporarily stores data such as a variable and a parameter to be used for processing executed by the CPU.

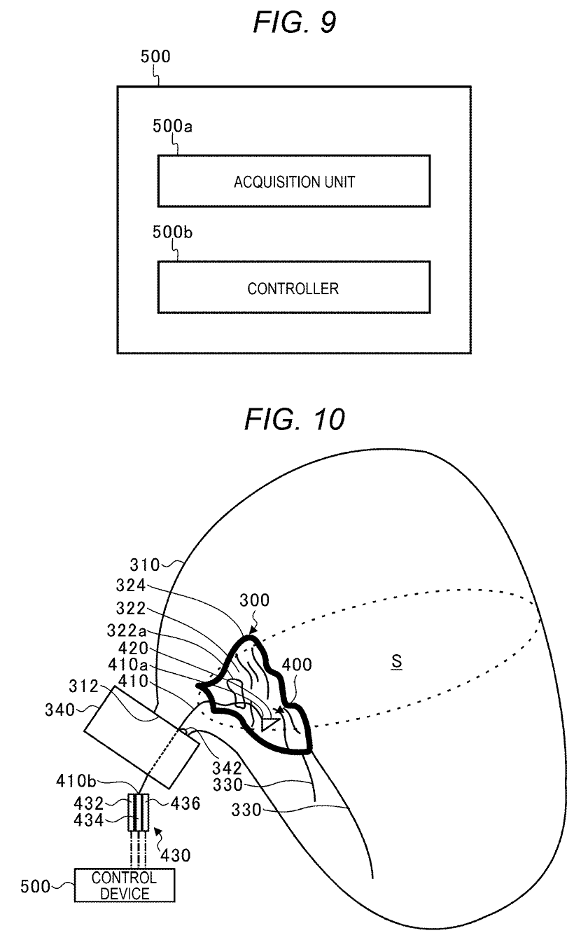

FIG. 9 is a block diagram illustrating an example of a functional configuration of the control device 500 according to the present embodiment. For example, as illustrated in FIG. 9, the control device 500 includes an acquisition unit 500a and a controller 500b.

The processor 540 executes a program included in the memory 550 in cooperation with the program included in the memory 550 to implement various kinds of processing including processing to be described below that is executed by the acquisition unit 500a and the controller 500b.

The acquisition unit 500aacquires a signal transmitted from the in-cabin sensor 200. In one example, the acquisition unit 500a acquires a signal indicating a collision between the vehicle 100 and an object from the collision sensor 210. The acquisition unit 500a acquires a signal indicating whether the seatbelt 700 is worn from the seatbelt wearing sensor 220. The acquisition unit 500a acquires a signal indicating a load applied to a seat from the seating sensor 230. The acquisition unit 500a acquires a signal indicating a size and a posture of the occupant 600 and a distance to the occupant 600 from the camera 240. The acquisition unit 500aacquires a signal indicating a size and a posture of the occupant 600 and a distance and an azimuth to the occupant 600 from the radar 250.

The controller 500b controls the inflator 340 and the actuator 430 based on the signals acquired by the acquisition unit 500a. In one example, when the signal indicating a collision between the vehicle 100 and an object is acquired from the collision sensor 210, the controller 500b controls the inflator 340 to eject a gas via the gas ejection port 342.

When the signal indicating a collision between the vehicle 100 and an object is acquired from the collision sensor 210, the controller 500b controls the actuator 430 based on a signal transmitted from the in-cabin sensor 200. Details of control processing of the actuator 430 by the controller 500b will be described later.

For example, at the time of a front collision of a vehicle, an occupant in a vehicle cabin of the vehicle is moved to a front side of the vehicle due to an impact of the collision, and an impact on the occupant is relieved by a collision with a deployed airbag. At this time, when the occupant wears a seatbelt, a restraint force of the seatbelt and a restraint force caused by pressure in a lower portion of the airbag act on the chest of the occupant, and a restraint force caused by pressure in an upper portion of the airbag acts on the head of the occupant.

On the other hand, when the occupant does not wear a seatbelt, a restraint force caused by pressure in the upper portion of the airbag acts on the head of the occupant, and a restraint force caused by pressure in a lower portion of the airbag acts on the chest of the occupant. In this manner, at the time of a vehicle collision, the distribution of restraint forces acting respectively on the head and the chest of the occupant may change in accordance with a state of the occupant, such as whether the occupant wears the seatbelt, and a load on the neck of the occupant may increase. Therefore, it is desirable to appropriately change the pressure in the upper portion and the pressure in the lower portion of the airbag in accordance with a state of the occupant at the time of a vehicle collision so as to improve safety of the occupant.

Therefore, the controller 500b in the present embodiment controls the removing mechanism 400 to remove the diaphragm 320 coupled to the inner surface 310a of the airbag main body 310 in accordance with a state of the occupant 600 seated on a seat. Here, the state of the occupant 600 seated on a seat includes whether the occupant 600 wears the seatbelt 700, a posture, a size, and a weight of the occupant 600.

In one example, first, the controller 500b determines whether a predetermined condition is satisfied based on a signal transmitted from the in-cabin sensor 200. When a predetermined condition is satisfied, the controller 500b controls the removing mechanism 400 to remove the diaphragm 320 from the inner surface 310a of the airbag main body 310.

When the predetermined condition is not satisfied, the controller 500b controls the removing mechanism 400 to not remove the diaphragm 320 from the inner surface 310a of the airbag main body 310. That is, when the predetermined condition is not satisfied, the controller 500b controls the removing mechanism 400 such that the inner surface 310a of the airbag main body 310 and the diaphragm 320 are maintained to be coupled. Hereinafter, detailed control processing of the controller 500b in the present embodiment will be described.

The predetermined condition includes, for example, information indicating that the occupant 600 wears the seatbelt 700, information indicating that a position of a seat of the occupant 600 is located on a front side of the vehicle 100 relative to a reference position, information indicating that a weight of the occupant 600 is a reference weight or more, and information indicating that a size of the occupant 600 is larger than a reference body size.

Here, the reference position of the seat is, for example, a seating reference point. The seating reference point refers to a position of a hip joint of a human model when the human model is seated on a seat based on ISO 6549-1980 or a design reference position set on a seat corresponding to the position.

The reference weight and the reference body size are, for example, a weight and a body size of AM50 (50th percentile of an American adult male). The weight of AM50 is, for example, approximately 78 kg. The body size of AM50 is, for example, a height of 175 cm and a seat height of 88 cm.

The controller 500b determines that the occupant 600 wears the seatbelt 700 based on a signal indicating whether the seatbelt 700 is worn, which is transmitted from the seatbelt wearing sensor 220.

The controller 500b determines that the position of the seat of the occupant 600 is located on a front side of the vehicle 100 relative to the reference position based on a signal indicating a size and a posture of the occupant 600 and a distance to the occupant 600, which is transmitted from the camera 240, and a signal indicating a size and a posture of the occupant 600 and a distance and an azimuth to the occupant 600, which is transmitted from the radar 250.

The controller 500b determines that the weight of the occupant 600 is the reference weight or more based on a signal indicating a load applied to the seat, which is transmitted from the seating sensor 230. The controller 500b determines that the size of the occupant 600 is larger than the reference body size based on a signal indicating a size and a posture of the occupant 600 and a distance to the occupant 600, which is transmitted from the camera 240, and a signal indicating a size and a posture of the occupant 600 and a distance and an azimuth to the occupant 600, which is transmitted from the radar 250.

In the present embodiment, the controller 500b controls the removing mechanism 400 to remove the diaphragm 320 from the inner surface 310a of the airbag main body 310 when the occupant 600 wears the seatbelt 700. On the other hand, the controller 500b controls the removing mechanism 400 to not remove the diaphragm 320 from the inner surface 310a of the airbag main body 310 when the occupant 600 does not wear the seatbelt 700.

When a signal indicating whether the seatbelt 700 is worn is not acquirable, the controller 500b controls the removing mechanism 400 based on a predetermined condition related to one or more of a posture, a weight, and a size of the occupant 600.

In one example, the controller 500b controls the removing mechanism 400 to remove the diaphragm 320 from the inner surface 310a of the airbag main body 310 when the position of the seat of the occupant 600 is located on a front side of the vehicle 100 relative to the reference position as the posture of the occupant 600. On the other hand, the controller 500b controls the removing mechanism 400 to not remove the diaphragm 320 from the inner surface 310a of the airbag main body 310 when the position of the seat of the occupant 600 is not located on the front side of the vehicle 100 relative to the reference position as the posture of the occupant 600.

The controller 500b controls the removing mechanism 400 to remove the diaphragm 320 from the inner surface 310a of the airbag main body 310 when the weight of the occupant 600 is the reference weight or more. On the other hand, the controller 500b controls the removing mechanism 400 to not remove the diaphragm 320 from the inner surface 310a of the airbag main body 310 when the weight of the occupant 600 is not the reference weight or more.

The controller 500b controls the removing mechanism 400 to remove the diaphragm 320 from the inner surface 310a of the airbag main body 310 when the size of the occupant 600 is larger than the reference body size. On the other hand, the controller 500b controls the removing mechanism 400 to not remove the diaphragm 320 from the inner surface 310a of the airbag main body 310 when the size of the occupant 600 is not larger than the reference body size.

A priority may be given to a predetermined condition related to a posture, a weight, and a size of the occupant 600. In this case, the controller 500b may control the removing mechanism 400 based on a condition having a high priority among the predetermined conditions. When all predetermined conditions related to a posture, a weight, and a size of the occupant 600 are satisfied, the removing mechanism 400 may be controlled to remove the diaphragm 320 from the inner surface 310a of the airbag main body 310.

Next, an operation of the removing mechanism 400 controlled by the controller 500b will be described. When the diaphragm 320 is not removed from the inner surface 310a of the airbag main body 310, the controller 500b controls the first actuator 432 and the third actuator 436 to maintain the protruding state of the pin 432a, as illustrated in FIG. 2. Accordingly, the pins 432a and the other ends 330b of the suture threads 330 in the pair are maintained in the locked state.

When the diaphragm 320 is not removed from the inner surface 310a of the airbag main body 310, the controller 500b controls the second actuator 434 to displace the pin 432a from the protruding state to the retracted state, as illustrated in FIG. 2. Accordingly, the pin 432aand the other end 410bof the suture releasing thread 410 is unlocked, and the pin 432a transitions from the locked state to the unlocked state.

In this state, when the controller 500b operates the inflator 340, the airbag main body 310 is inflated and deployed by the pressure of the gas ejected from the gas ejection port 342 of the inflator 340. At this time, the other ends 330bof the suture threads 330 are maintained in the locked state by the pins 432a of the first actuator 432 and the third actuator 436.

Therefore, along with inflation and deployment of the airbag main body 310, the airbag main body 310 and the diaphragm 320 sewn by the suture thread 330 are maintained to be coupled to each other without releasing the sewing of the suture thread 330. As a result, along with inflation and deployment of the airbag main body 310, the diaphragm 320 is deployed in the airbag main body 310 as illustrated in FIG. 2, while being maintained to be coupled to the inner surface 310a of the airbag main body 310. At this time, the deployed diaphragm 320 divides the internal space S of the airbag main body 310 into the upper space S1 and the lower space S2.

FIG. 10 is a perspective view illustrating the airbag device 300 in a state in which the diaphragm 320 is removed from the inner surface 310a of the airbag main body 310 by the removing mechanism 400 according to the present embodiment. When the diaphragm 320 is removed from the inner surface 310a of the airbag main body 310, the controller 500b controls the second actuator 434 to maintain the protruding state of the pin 432a, as illustrated in FIG. 10. Accordingly, the locked state between the pin 432aand the other end 410b of the suture releasing thread 410 is maintained.

When the diaphragm 320 is removed from the inner surface 310a of the airbag main body 310, the controller 500b controls the first actuator 432 and the third actuator 436 to displace the pins 432a from the protruding state to the retracted state, as illustrated in FIG. 10. Accordingly, the pins 432aand the other ends 330bof the suture threads 330 in the pair are unlocked, and the pins 432a transition from the locked state to the unlocked state.

In this state, when the controller 500b operates the inflator 340, the airbag main body 310 is inflated and deployed by the pressure of the gas ejected from the gas ejection port 342 of the inflator 340. At this time, the pin 432aof the second actuator 434 maintains the locked state of the other end 410b of the suture releasing thread 410. On the other hand, the pin 432aof the first actuator 432 and the pin 432a of the third actuator 436 and the other ends 330b of the suture threads 330 in the pair are unlocked, and the pins 432a are in the unlocked state.

As described above, since the total length of the suture releasing thread 410 is sufficiently short relative to a long diameter of the diaphragm 320, a portion of the outer peripheral portion 324 of the diaphragm 320 on a side close to the occupant 600 is held in the vicinity of the inflator 340 by the coupling structure body 420 in the locked state in which the suture releasing thread 410 is locked to the second actuator 434.

On the other hand, the airbag main body 310 is inflated and deployed by the gas pressure of the inflator 340. Therefore, there is a force that separates a portion of the inner surface 310a of the airbag main body 310 on a side close to the occupant 600 from the portion of the outer surface 324a of the outer peripheral portion 324 of the diaphragm 320 on a side close to the occupant 600. This separation force is generated by the gas pressure of the inflator 340 and a tension of the suture releasing thread 410.

That is, a force in a direction approaching the occupant 600 is applied to the portion of the inner surface 310a of the airbag main body 310 on a side close to the occupant 600 due to the gas pressure of the inflator 340. On the other hand, a tensile load in a direction away from the occupant 600 is applied to the portion of the outer surface 324a of the outer peripheral portion 324 of the diaphragm 320 on a side close to the occupant 600 due to the tension of the suture releasing thread 410.

The force that separates the inner surface 310a of the airbag main body 310 from the outer surface 324a of the outer peripheral portion 324 of the diaphragm 320 causes the suture threads 330 in the pair of which the other ends 330b are in the unlocked state to be pulled out from the seam between the airbag main body 310 and the outer peripheral portion 324. Accordingly, a separation distance between the airbag main body 310 and the outer peripheral portion 324 increases as the airbag main body 310 and the outer peripheral portion 324 are unsewed.

Finally, the airbag main body 310 and the outer peripheral portion 324 sewed by the suture threads 330 in the pair are completely unsewed, and as illustrated in FIG. 10, the diaphragm 320 is separated from a coupling portion between the inner surface 310a of the airbag main body 310 and the outer surface 324a of the outer peripheral portion 324, and the diaphragm 320 is detached. In this manner, the diaphragm 320 is removed from the inner surface 310a of the airbag main body 310.

FIG. 11 is a schematic diagram illustrating pressure inside the airbag main body 310 when the diaphragm 320 is not removed according to the embodiment. As described above, the gas ejection port 342 of the inflator 340 is disposed below the diaphragm 320 in the opening 312 of the airbag main body 310. Therefore, the gas ejected from the gas ejection port 342 passes below the diaphragm 320 in the opening 312 and is supplied to the lower space S2 of the airbag main body 310.

The gas supplied to the lower space S2 inflates the lower space S2 of the airbag main body 310. The gas supplied to the lower space S2 is supplied to the upper space S1 via the vent hole 322a (see FIG. 2) of the diaphragm 320. Then, the gas supplied to the upper space S1 inflates the upper space S1 of the airbag main body 310.

In this manner, the gas ejected from the gas ejection port 342 is supplied in the order of the lower space S2 to the upper space S1 of the airbag main body 310. Since the gas is supplied to the lower space S2 prior to the upper space S1, an amount of the gas supplied into the lower space S2 is larger than an amount of the gas supplied to the upper space S1, and as a result, pressure of the gas in the lower space S2 is larger than pressure of the gas in the upper space S1.

That is, since the diaphragm 320 is provided inside the airbag main body 310, a pressure difference can be provided between the upper space S1 and the lower space S2 divided by the diaphragm 320. In other words, since the diaphragm 320 is provided inside the airbag main body 310, a ratio of the pressure in the lower space S2 to the pressure in the upper space S1 can be set. Hereinafter, a ratio of the pressure in the lower space S2 to the pressure in the upper space S1 may be simply referred to as a "pressure ratio".

The pressure ratio can be set in accordance with a size and a position of the vent hole 322a. In one example, as the size of the vent hole 322a decreases, the amount of the gas supplied from the lower space S2 to the upper space S1 decreases, and the pressure ratio can be set to be larger.

Further, as the position of the vent hole 322a is separated from the inflator 340 relative to the center O of the diaphragm 320, a time up to when the gas ejected by the inflator 340 reaches the vent hole 322a through the lower space S2 becomes longer. Therefore, as the position of the vent hole 322a is separated from the inflator 340 relative to the center O of the diaphragm 320, the amount of the gas supplied from the lower space S2 to the upper space S1 becomes smaller, and the pressure ratio can be set to be larger.

As illustrated in FIG. 11, at the time of a collision of the vehicle 100, the controller 500b causes the airbag main body 310 to be inflated and deployed to generate restraint forces to relieve an impact on the occupant 600. At this time, an upper portion of the airbag main body 310 corresponding to the upper space S1 above the diaphragm 320 comes into contact with a head 610 of the occupant 600 and applies a restraint force F_{H} to the head 610 of the occupant 600. A lower portion of the airbag main body 310 corresponding to the lower space S2 below the diaphragm 320 comes into contact with a chest 620 of the occupant 600 and applies a restraint force F_{C} to the chest 620 of the occupant 600.

The restraint force F_{H}, which is applied from the upper portion of the airbag main body 310 to the head 610 of the occupant 600, changes in accordance with the pressure in the upper space S1 of the airbag main body 310 and a contact area of the head 610 of the occupant 600 that comes into contact with the upper portion of the airbag main body 310. Similarly, the restraint force F_{C}, which is applied from the lower portion of the airbag main body 310 to the chest 620 of the occupant 600, changes in accordance with the pressure in the lower space S2 of the airbag main body 310 and a contact area of the chest 620 of the occupant 600 that comes into contact with the lower portion of the airbag main body 310. Hereinafter, a ratio of a contact area of the chest 620 to a contact area of the head 610 with the airbag main body 310 may be simply referred to as a contact area ratio.

A ratio of the restraint force F_{C} applied to the chest 620 to the restraint force F_{H} applied to the head 610 is set to a ratio of a mass of the chest 620 to a mass of the head 610. Hereinafter, a ratio of the restraint force F_{C} to the restraint force F_{H} may be simply referred to as a restraint force ratio. A ratio of the mass of the chest 620 to the mass of the head 610 may be simply referred to as a mass ratio.

For example, a ratio of the mass of the head 610 to the mass of the chest 620 of the occupant 600 is 1:5. A ratio of the contact area of the head 610 with the airbag main body 310 to the contact area of the chest 620 with the airbag main body 310 is, for example, 1:2. In this case, a ratio of the pressure in the upper space S1 to the pressure in the lower space S2 of the airbag main body 310 is set to, for example, 1:2.5.

In the present embodiment, the ratio (1:5) of the mass of the head 610 to the mass of the chest 620 of the occupant 600 = the ratio (1:5) of the restraint force F_{C} applied to the chest 620 to the restraint force F_{H} applied to the head 610 = the ratio (1:2) of the contact area of the head 610 to the contact area of the chest 620 with the airbag main body 310 x the ratio (1:2.5) of the pressure in the upper space S1 to the pressure in the lower space S2 of the airbag main body 310.

In this manner, the pressure ratio of the airbag main body 310 is set in accordance with the mass ratio of the head 610 to the chest 620 of the occupant 600 and the contact area ratio of the head 610 to the chest 620 with the airbag main body 310. Accordingly, a restraint force in accordance with the mass ratio of the head 610 to the chest 620 of the occupant 600 can be applied from the airbag main body 310 to the head 610 and the chest 620 of the occupant 600. Thus, in a state in which the occupant 600 does not wear the seatbelt 700, the same deceleration can be applied to the head 610 and the chest 620 of the occupant 600 at the time of a collision of the vehicle 100. As a result, bending and extension of the neck of the occupant 600 at the time of a collision of the vehicle 100 can be prevented, and a load on the neck of the occupant 600 can be reduced.

FIG. 12 is a schematic diagram illustrating pressure inside the airbag main body 310 when the diaphragm 320 is removed according to the present embodiment. When the diaphragm 320 is removed by the removing mechanism 400, the internal space S of the airbag main body 310 is not divided into the upper space S1 and the lower space S2 by the diaphragm 320. Therefore, the gas ejected from the gas ejection port 342 of the inflator 340 is supplied to the whole internal space S of the airbag main body 310, and the pressure inside the internal space S of the airbag main body 310 is uniform without a pressure difference.

As illustrated in FIG. 12, at the time of a collision of the vehicle 100, the controller 500bcauses the airbag main body 310 to be inflated and deployed to generate restraint forces to relieve an impact on the occupant 600. At this time, the occupant 600 wears the seatbelt 700, and a restraint force F_{S} applied by the seatbelt 700 is applied to the chest 620 of the occupant 600.

The restraint force F_{H}, which is applied from the upper portion of the airbag main body 310 to the head 610 of the occupant 600, changes in accordance with the pressure in the internal space S of the airbag main body 310 and a contact area of the head 610 of the occupant 600 that comes into contact with the upper portion of the airbag main body 310. Similarly, the restraint force F_{C}, which is applied from the lower portion of the airbag main body 310 to the chest 620 of the occupant 600, changes in accordance with the pressure in the internal space S of the airbag main body 310 and a contact area of the chest 620 of the occupant 600 that comes into contact with the lower portion of the airbag main body 310.

For example, a ratio of the mass of the head 610 to the mass of the chest 620 of the occupant 600 is 1:5. The ratio of the contact area of the head 610 to the contact area of the chest 620 with the airbag main body 310 is, for example, 1:2.

In the present embodiment, the ratio (1:5) of the mass of the head 610 to the mass of the chest 620 of the occupant 600 = the ratio (1:5) of the restraint force F_{C} + FS applied to the chest 620 to the restraint force F_{H} applied to the head 610 = the ratio (1:2) of the contact area of the head 610 to the contact area of the chest 620 with the airbag main body 310 x the ratio (1:1) of the pressure in the internal space S of the airbag main body 310 + the restraint force F_{S} of the seatbelt 700 applied to the chest 620 of the occupant 600.

Accordingly, a restraint force in accordance with the mass ratio of the head 610 to the chest 620 of the occupant 600 can be applied from the airbag main body 310 to the head 610 and the chest 620 of the occupant 600 in cooperation with the seatbelt 700. Thus, the same deceleration can be applied to the head 610 and the chest 620 of the occupant 600 at the time of a collision of the vehicle 100. As a result, bending and extension of the neck of the occupant 600 at the time of a collision of the vehicle 100 can be prevented, and a load on the neck of the occupant 600 can be reduced.

As described above, the airbag device 300 in the present embodiment includes the suture thread 330 that detachably couples the outer peripheral portion 324 of the diaphragm 320 to the inner surface 310a of the airbag main body 310. The airbag device 300 includes the removing mechanism 400 that removes the diaphragm 320 coupled to the inner surface 310a of the airbag main body 310 in accordance with a state of the occupant 600 seated on a seat. Accordingly, regardless of the state of the occupant 600 seated on the seat, a restraint force in accordance with the mass ratio of the head 610 to the chest 620 of the occupant 600 can be applied from the airbag main body 310 to the head 610 and the chest 620 of the occupant 600. Thus, the same deceleration can be applied to the head 610 and the chest 620 of the occupant 600 at the time of a collision of the vehicle 100. As a result, bending and extension of the neck of the occupant 600 at the time of a collision of the vehicle 100 can be prevented, and a load on the neck of the occupant 600 can be reduced. Therefore, at the time of a collision of the vehicle 100, the pressure in the upper portion and the pressure in the lower portion of the airbag main body 310 can be appropriately changed in accordance with the state of the occupant 600, so that safety of the occupant 600 can be improved.

For example, the inflator 340 ejects a gas into the lower space S2 of the airbag main body 310. In a case where the occupant 600 wears the seatbelt 700, the removing mechanism 400 removes the diaphragm 320 from the inner surface 310a of the airbag main body 310 when the airbag main body 310 is inflated by pressure of the gas ejected by the inflator 340. In a case where the occupant 600 does not wear the seatbelt 700, the removing mechanism 400 does not remove the diaphragm 320 from the inner surface 310a of the airbag main body 310 when the airbag main body 310 is inflated by the pressure of the gas ejected by the inflator 340. Accordingly, regardless of whether the occupant 600 seated on a seat wears the seatbelt 700, a restraint force in accordance with the mass ratio of the head 610 to the chest 620 of the occupant 600 can be applied from the airbag main body 310 to the head 610 and the chest 620 of the occupant 600. Thus, the same deceleration can be applied to the head 610 and the chest 620 of the occupant 600 at the time of a collision of the vehicle 100. As a result, bending and extension of the neck of the occupant 600 at the time of a collision of the vehicle 100 can be prevented, and a load on the neck of the occupant 600 can be reduced.

For example, when the airbag main body 310 is inflated by the pressure of the gas ejected by the inflator 340, the removing mechanism 400 removes the diaphragm 320 from the inner surface 310a of the airbag main body 310 based on a predetermined condition related to one or more of the posture, the weight, and the size of the occupant 600. Accordingly, the diaphragm 320 can be removed when a predetermined condition is satisfied in accordance with a state of the occupant 600 seated on a seat.

For example, the removing mechanism 400 removes the diaphragm 320 from the inner surface 310a of the airbag main body 310 when the position of the seat of the occupant 600 is located on a front side of the vehicle 100 relative to the reference position as the posture of the occupant 600. Here, as the position of the seat of the occupant 600 is located closer to the front side of the vehicle 100 relative to the reference position, a collision time with a member provided in front of the occupant 600 becomes shorter. As the collision time becomes shorter, an inflation amount of the airbag main body 310 decreases. Further, when the diaphragm 320 is provided inside the airbag main body 310, a deployment speed of the airbag main body 310 is slowed down due to a pressure loss in the vent hole 322a. Therefore, as the position of the seat of the occupant 600 is located closer to the front side of the vehicle 100 relative to the reference position, the airbag main body 310 is less likely to absorb an impact. Therefore, when the position of the seat of the occupant 600 is located on the front side of the vehicle 100 relative to the reference position, the removing mechanism 400 removes the diaphragm 320 from the inner surface 310a of the airbag main body 310.

On the other hand, when the position of the seat of the occupant 600 is not located on the front side of the vehicle 100 relative to the reference position as a posture of the occupant 600, the removing mechanism 400 does not remove the diaphragm 320 from the inner surface 310a of the airbag main body 310. Here, as the position of the seat of the occupant 600 is located on a rear side of the vehicle 100 relative to the reference position, a distance between the occupant 600 and the airbag main body 310 becomes larger, and a restraint balance between the head 610 and the chest 620 of the occupant 600 becomes more likely to be misaligned. Therefore, when the position of the seat of the occupant 600 is located on the rear side of the vehicle 100 relative to the reference position, the removing mechanism 400 maintains the diaphragm 320 on the inner surface 310a of the airbag main body 310 in order to maintain a restraint balance between the head 610 and the chest 620 of the occupant 600.

For example, when the weight of the occupant 600 is a reference weight or more, the removing mechanism 400 removes the diaphragm 320 from the inner surface 310a of the airbag main body 310. Here, as the weight of the occupant 600 becomes larger than the reference weight, an impact applied to the occupant 600 is likely to become larger. Therefore, when the weight of the occupant 600 is the reference weight or more, the removing mechanism 400 removes the diaphragm 320 from the inner surface 310a of the airbag main body 310 in order to easily absorb the impact applied to the occupant 600 over a wider area.

Otherwise, the removing mechanism 400 does not remove the diaphragm 320 from the inner surface 310a of the airbag main body 310 when the weight of the occupant 600 is not the reference weight or more. Here, a child or a person of a small size tends to have a weak neck resistance and the neck is likely to be damaged during a vehicle collision. Therefore, when the weight of the occupant 600 is not the reference weight or more, the removing mechanism 400 does not remove the diaphragm 320 from the inner surface 310a of the airbag main body 310 so as to relieve damage to the neck of the occupant 600.

For example, when the size of the occupant 600 is larger than a reference body size, the removing mechanism 400 removes the diaphragm 320 from the inner surface 310a of the airbag main body 310. Here, as the size of the occupant 600 becomes larger than the reference body size, an impact applied to the occupant 600 is likely to become larger. Therefore, when the size of the occupant 600 is larger than the reference body size, the removing mechanism 400 removes the diaphragm 320 from the inner surface 310a of the airbag main body 310 in order to easily absorb the impact applied to the occupant 600 over a wider area.

On the other hand, when the size of the occupant 600 is not larger than the reference body size, the removing mechanism 400 does not remove the diaphragm 320 from the inner surface 310a of the airbag main body 310. Here, a child or a person of a small size tends to have a weak neck resistance and the neck is likely to be damaged during a vehicle collision. Therefore, when the size of the occupant 600 is not larger than the reference body size, the removing mechanism 400 does not remove the diaphragm 320 from the inner surface 310a of the airbag main body 310 so as to reduce damage to the neck of the occupant 600.

For example, when the airbag main body 310 is inflated by the pressure of the gas ejected by the inflator 340, the removing mechanism 400 uses an inflation force of the airbag main body 310 to separate the outer peripheral portion 324 of the diaphragm 320 from the inner surface 310a of the airbag main body 310, thereby removing the diaphragm 320. Accordingly, when the diaphragm 320 is removed, it is not necessary to additionally provide a drive device to separate the outer peripheral portion 324 of the diaphragm 320 from the inner surface 310a of the airbag main body 310. Therefore, the airbag device 300 including the removing mechanism 400 can be simplified, and the number of components can be reduced.

For example, the removing mechanism 400 includes the suture releasing thread 410 to which one end of the outer peripheral portion 324 of the diaphragm 320 is coupled, the actuator 430 switchable between a locked state in which the suture releasing thread 410 locks one end of the outer peripheral portion 324 of the diaphragm 320 when the airbag main body 310 is inflated and an unlocked state in which the suture releasing thread 410 unlocks the one end of the outer peripheral portion 324 of the diaphragm 320 when the airbag main body 310 is inflated. Accordingly, in accordance with a state of the occupant 600 seated on the seat, the actuator can easily switch between a state of maintaining the diaphragm 320 coupled to the inner surface 310a of the airbag main body 310 and a state of removing the diaphragm 320 from the inner surface 310a of the airbag main body 310.

For example, when the airbag main body 310 is inflated while the outer peripheral portion 324 of the diaphragm 320 and the inner surface 310a of the airbag main body 310 are coupled to each other, a pressure difference is generated between the pressure in the upper space S1 and the pressure in the lower space S2. A ratio of the pressure in the lower space S2 to the pressure in the upper space S1 is set based on a ratio of the mass of the chest 620 of the occupant 600 to the mass of the head 610 of the occupant 600. Accordingly, a restraint force in accordance with the mass ratio of the head 610 to the chest 620 of the occupant 600 can be applied from the airbag main body 310 to the head 610 and the chest 620 of the occupant 600.

Embodiments of the disclosure have been described above with reference to the accompanying drawings. It is needless to say that the disclosure is not limited to the embodiments described above. Various modifications and modification examples in the range described in claims also fall within the technical scope of the disclosure.

An example is described in the above embodiment in which the inflator 340 supplies a gas to the lower space S2 of the airbag main body 310. However, this is not to be construed in a limiting sense. The inflator 340 may, for example, supply a gas to the upper space S1 of the airbag main body 310.

An example is described in the above embodiment in which the other end 330b of the suture thread 330 and the other end 410b of the suture releasing thread 410 are locked by the pin 432a. However, this is not to be construed in a limiting sense. The other end 330b of the suture thread 330 and the other end 410b of the suture releasing thread 410 may not be locked by the pin 432a. For example, the other end 330b of the suture thread 330 and the other end 410b of the suture releasing thread 410 may be fixed by a fixing member such as a housing of the inflator 340. In this case, the actuator 430 may include, for example, a blade, and the blade may selectively cut the other end 330b of the suture thread 330 and the other end 410b of the suture releasing thread 410. In any case, the actuator 430 may be configured to switch the other end 330b of the suture thread 330 and the other end 410b of the suture releasing thread 410 between the locked state and the unlocked state.

According to the embodiment of the disclosure, it is possible to appropriately change the pressure in the upper portion and the pressure in the lower portion of the airbag in accordance with a state of the occupant at the time of a vehicle collision so as to improve safety of the occupant.

1. An airbag device comprising:
an airbag main body;
a diaphragm that is disposed inside the airbag main body, that divides an internal space of the airbag main body into an upper space and a lower space, and that has a ventilation hole allowing communication between the upper space and the lower space;
an inflator configured to eject a gas into one of the lower space and the upper space of the airbag main body from a gas inflow port of the airbag main body;
a coupling member configured to detachably couple an outer peripheral portion of the diaphragm to an inner surface of the airbag main body; and
a removing mechanism configured to remove the diaphragm coupled to the inner surface of the airbag main body according to a state of an occupant seated on a seat.

2. The airbag device according to claim 1, wherein
the inflator ejects the gas into the lower space of the airbag main body,
the removing mechanism is configured to, when the occupant wears a seatbelt, remove the diaphragm from the inner surface of the airbag main body when the airbag main body is inflated by pressure of the gas ejected from the inflator, and
the removing mechanism is configured, when the occupant does not wear the seatbelt, not to remove the diaphragm from the inner surface of the airbag main body when the airbag main body is inflated by the pressure of the gas ejected from the inflator.

3. The airbag device according to claim 1, wherein
the removing mechanism is configured, when the airbag main body is inflated by pressure of the gas ejected from the inflator, remove the diaphragm from the inner surface of the airbag main body based on a predetermined condition related to one or more of a posture, a weight, and a size of the occupant.

4. The airbag device according to claim 1, wherein
the removing mechanism is configured to, when the airbag main body is inflated by pressure of the gas ejected from the inflator, remove the diaphragm by peeling the outer peripheral portion of the diaphragm from the inner surface of the airbag main body using an inflation force of the airbag main body.

5. The airbag device according to claim 1, wherein
the removing mechanism comprises
a coupling member to which one end of the outer peripheral portion of the diaphragm is coupled, and
a switching unit configured to switch between a locked state in which the coupling member locks the one end of the outer peripheral portion of the diaphragm when the airbag main body is inflated and an unlocked state in which the coupling member does not lock the one end of the outer peripheral portion of the diaphragm when the airbag main body is inflated.

6. The airbag device according to claim 1, wherein
when the airbag main body is inflated while the outer peripheral portion of the diaphragm and the inner surface of the airbag main body are coupled to each other, a pressure difference is generated between pressure in the upper space and pressure in the lower space, and
a ratio of the pressure in the lower space to the pressure in the upper space is set based on a ratio of a mass of a chest of the occupant to a mass of a head of the occupant.

7. The airbag device according to claim 2, wherein
when the airbag main body is inflated while the outer peripheral portion of the diaphragm and the inner surface of the airbag main body are coupled to each other, a pressure difference is generated between pressure in the upper space and pressure in the lower space, and
a ratio of the pressure in the lower space to the pressure in the upper space is set based on a ratio of a mass of a chest of the occupant to a mass of a head of the occupant.

8. The airbag device according to claim 3, wherein
when the airbag main body is inflated while the outer peripheral portion of the diaphragm and the inner surface of the airbag main body are coupled to each other, a pressure difference is generated between pressure in the upper space and pressure in the lower space, and
a ratio of the pressure in the lower space to the pressure in the upper space is set based on a ratio of a mass of a chest of the occupant to a mass of a head of the occupant.

9. The airbag device according to claim 4, wherein
when the airbag main body is inflated while the outer peripheral portion of the diaphragm and the inner surface of the airbag main body are coupled to each other, a pressure difference is generated between pressure in the upper space and pressure in the lower space, and
a ratio of the pressure in the lower space to the pressure in the upper space is set based on a ratio of a mass of a chest of the occupant to a mass of a head of the occupant.

10. The airbag device according to claim 5, wherein
when the airbag main body is inflated while the outer peripheral portion of the diaphragm and the inner surface of the airbag main body are coupled to each other, a pressure difference is generated between pressure in the upper space and pressure in the lower space, and
a ratio of the pressure in the lower space to the pressure in the upper space is set based on a ratio of a mass of a chest of the occupant to a mass of a head of the occupant.
